(19) United States
(12) Patent Application Publication
(10) Pub. No.: US 2022/0288561 A1
(43) Pub. Date: Sep. 15, 2022

(54) POROUS TITANIA PHOTOCATALYST ON QUARTZ FIBERS AND METHODS OF USING THE SAME FOR CHEMICAL-FREE UV-AOP IN WATER TREATMENT

(71) Applicant: Board of Supervisors of Louisiana State University and Agricultural and Mechanical College, Baton Rouge, LA (US)

(72) Inventors: Daniel E. Willis, Baton Rouge, LA (US); Kevin M. McPeak, Baton Rouge, LA (US)

(21) Appl. No.: 17/690,562

(22) Filed: Mar. 9, 2022

Related U.S. Application Data
(60) Provisional application No. 63/159,002, filed on Mar. 10, 2021.

(51) Int. Cl. B01J 21/06; B01J 21/08; B01J 35/00; B01J 37/34; C02F 1/72

(52) U.S. Cl. CPC B01J 21/063; B01J 21/08; B01J 35/0006; B01J 37/345; B01J 35/004; C02F 1/725

(57) ABSTRACT

The present disclosure provides for methods and systems that include a support of optically transparent quartz fibers having a meso-porous layer of TiO₂-based catalytic layer on the fibers. The methods, systems, and compositions of the present disclosure provide chemical-free advanced oxidation to improve the affordability of UV AOPs for water treatment.

### CROSS-REFERENCE TO RELATED APPLICATIONS

This application claims the benefit of and priority to U.S. Provisional Application Ser. No. 63/159,002, having the title “POROUS TITANIA PHOTOCATALYST ON QUARTZ FIBERS AND METHODS OF USING THE SAME FOR CHEMICAL-FREE UV-AOP IN WATER TREATMENT,” filed on Mar. 10, 2021, the disclosure of which is incorporated herein in by reference in their entireties.

### BACKGROUND

Municipalities and companies are investing heavily in water recycling and reuse projects. Standards for water reuse require high decontamination levels of a variety of pollutants. To meet EPA standards for water reuse, UV-driven advanced oxidation process (AOP) are often implemented, despite the high costs of chemical additives and electrical demand. This involves the dosing of upwards of 50 ppm H₂O₂ into pre-filtered water continuously while illuminating the system with high-power UV-C radiation. However, this is an expensive process and alternative processes are needed.

### SUMMARY

Embodiments of the present disclosure provides for compositions, methods and systems that include a support of optically transparent quartz fibers having a meso-porous layer of TiO₂-based catalytic layer on the fibers

The present disclosure provides for methods of treating water, comprising: exposing a plurality of coated quartz fibers to water of need of treatment in the presence of UV radiation; generating, in situ, reactive oxygen species that decontaminate the water in need of treatment; and producing decontaminated water. The UV radiation has a wavelength of about 200 nm to 400 nm and the treatment in the presence of UV radiation is performed for a time frame of about mins to days. The method of producing decontaminated water can be performed without the need to implement a separate chemical additive, where the chemical additive is hydrogen peroxide, ozone, perchlorate, or a combination thereof.

The present disclosure also provides for systems for treating water, comprising: a water flow system; and a water treatment device, wherein the water flow system is configured to flow water into and out of the water treatment device, wherein the water treatment device includes a structure that includes a plurality of coated quartz fibers, wherein the water treatment device also includes a UV radiation device configured to direct UV radiation upon the coated quartz fibers, wherein water of need of treat is flowed into the water treatment device using the water flow system, wherein decontaminated water flows out of the water treatment device after exposure of the coated quartz fibers to the UV radiation.

The present disclosure provides for compositions comprising: a plurality of coated quartz fibers, wherein the coated quartz fibers comprise quartz fiber having a TiO₂-based catalytic layer on the surface of the quartz fiber.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1C illustrate electron micrographs of the P25/QF photocatalyst at varying magnifications and FIG. 1D illustrates an electron micrograph of the P25/glass surface, along with FIG. 1E illustrates an x-ray tomograph of the P25/QF structure, with arrows depicting the direction of fluid flow relative to the fibers. FIG. 1F illustrates a photograph of the 50 mm×50 mm P25/QF photocatalyst at macroscale. FIG. 1G illustrates an x-ray diffraction scan for the P25/QF sample showing a mixed anatase/rutile titania phase.

FIG. 2 illustrates a schematic of the continuous-flow reaction system with both single-pass flow measurements (analyzed with an in-line spectrofluorometer) and/or a recycled stream for recycled batch testing.

FIGS. 3A-3F illustrate the performance of photocatalyst under UVA and UVC illumination, as compared in FIGS. 3A-3B which show OH generation rate and FIGS. 3C-3D show RhB degradation rate constants. FIG. 3A illustrates a comparison of fractional absorption of UV light for samples and FIG. 3F illustrates their respective E_{EO} under both UV illumination sources.

FIG. 4A-4C illustrates evaluating the effect of P25/QF thickness on photocatalytic performance in single-pass flow tests. FIG. 4A illustrates the absorptance spectra, FIG. 4B illustrates hydroxyl radical generation, and FIG. 4C illustrates relevant optical efficiency metrics for various P25/QF(X) samples

FIGS. 5A-5D illustrate the effect of flow rate and illumination intensity in recycled batch test. FIG. 5A illustrates RhB degradation under 3.5 mW/cm² UVA, with batch data fit to single-pass conversion model (dashed lines). FIG. 5B illustrates the apparent rate constant for RhB degradation under different UVA intensities and flow rates. FIG. 5C illustrates the rate constant for single-pass degradation of RhB under UVA and UVC. FIG. 5D illustrates the E_{EO} for RhB degradation by P25/QF(50) under UVA and UVC with a 2.55 mL/min flow rate.

FIGS. 6A-6C illustrate the performance of P25/QF in various water sources. FIG. 6A illustrates the first-order kinetic breakdown of RhB by P25/QF under UVA and UVC light in both DI and SSW. FIG. 6B illustrates the compartive RhB degradation of P25/QF under UVC illumination and a traditional H₂O₂/UVC AOP various H₂O₂ concentrations. FIG. 6C illustrates the degradation of model pharmaceutical compounds in RWS under various photocatalytic conditions.

### DETAILED DESCRIPTION

Embodiments of the present disclosure provides for methods and systems that include a support of optically transparent quartz fibers having a meso-porous layer of TiO₂-based catalytic layer on the fibers. The methods, systems, and compositions of the present disclosure provide chemical-free advanced oxidation to improve the affordability of UV AOPs for water treatment.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, materials science, mechanical engineering, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### Discussion

Water scarcity is a growing threat to human prosperity worldwide. Water reclamation technologies, which typically employ advanced oxidation processes (AOPs) driven by ultraviolet (UV) light and chemical additives (H₂O₂, O₃, etc.), offer a solution to water shortages. Photocatalytic AOPs could further improve water reuse technologies by offering chemical-free, energy-efficiency water treatment. Unfortunately, current photocatalytic AOPs are not economically viable due to mass transfer limitations and poor light management.

Embodiments of the present disclosure provide methods and systems that use a supported photocatalyst for UV-driven water treatment. In an aspect, the present disclosure comprises a support of optically transparent quartz fibers having a meso-porous layer of TiO₂-based catalytic material on the fibers. In regard to the method or system, contaminated water (e.g., non-potable water, not fit for consumption based on state and US Federal standards or otherwise contaminated and needs processing for other uses) can be introduced to this material and exposed to an environment under ultraviolet (UV) illumination, for example in the range of 100 nm to 400 nm (or about 100 to 280 nm, about 280-315 nm, about 315-400 nm, or any combination of these ranges) excitation wavelength for an appropriate time frame. Embodiments of the present disclosure can provide in situ generation of reactive oxygen species which can break down environmental contaminants during in a UV advanced oxidation process (AOP) without the need to implement a separate chemical additive, be it hydrogen peroxide, ozone, and/or perchlorate.

In this regard, embodiments of the present disclosure can provide chemical-free advanced oxidation to improve the affordability of UV AOPs for water treatment. Service companies typically implement UV AOPs as the final step of water treatment trains to ensure regulatory standards are met and the effluent water is safe for the end-users. Most water reuse manufacturers implement UV AOPs systems with UV-C lamps and a continuous chemical oxidant supply (ex. bulk H₂O₂). In some systems, it is estimated that the 25-50% of the annualized cost of implementing UV AOPs is driven by the addition and quenching of chemical oxidants like H₂O₂.

Commercial UV AOPs can be made more affordable by substituting continuous chemical dosing through in situ photocatalytic generation of oxidants. In particular, embodiments of the present disclosure generate the hydroxyl radicals in situ with UV-C illumination, removing the need to dose the UV system with a chemical additive. Highly effective and stable photocatalyst generate hydrogen peroxide (H₂O₂) and hydroxyl radicals (*OH) under UV illumination. This approach should be able to save significant resources.

In particular aspects as described in more detail in Example 1, a dual-porous photocatalytic AOP including a mesoporous (i.e., about 2-50 nm pores) P25 TiO₂ photocatalyst supported on macroporous (i.e., about 50 nm pores or more) fuzed quartz fibers (i.e., “P25/QF”). These photocatalytic AOPs can replace chemical additives and can exhibit excellent commercial viability with an electrical energy per order (E_{EO}) of 0.6 kWh/m³ for a textile dye (Rhodamine B, RhB) in natural waters. The P25/QF system of the present disclosure can generate hydroxyl radicals that break down RhB about 2.5-times faster than a non-porous titania photocatalyst on quartz fibers (Tnp/QF) and about 6-times faster than single porosity titania films on glass slides (P25/glass), highlighting the importance of these dual-porosity design. The present disclosure can also degrade various common micropollutants (e.g., pharmaceutical compounds (Acetaminophen, Sulfamethoxazole, & Carbamazepine)) found in natural waters with E_{EO} values of 0.59, 4.07, 0.96, and 1.35 kWh/m³/order, respectively. These improvements are examined based on mass transport and optical (UVA and UVC) transmission and make first attempts to optimize the photocatalytic system. Compared to traditional H₂O₂/UVC AOP process, the presently disclosed photocatalytic AOPs can treat water—without chemical additives—while saving nearly 3000% on energy consumption.

Having described aspects of the present disclosure, additional features and details we now be described. The present disclosure comprises a support of optically transparent quartz fibers having a meso-porous layer of TiO₂-based catalytic layer on the fibers. In particular, the macroporous transparent quartz fibers can have a mesoporous layer of TiO₂-based catalytic layer on the fibers. The quartz fibers can have a diameter of about 2 to 10 μm, about 4 to 8 μm, or about 6 μm, where each quartz fiber can have the same diameter or the quartz fibers can have a variety of diameters, some are the same while some are different. The quartz fibers can have a length of about 1 mm to 100 cm or higher (e.g., 1 m) and can have the same length or different lengths. The quartz fibers can be macroporous (i.e., about 50 nm 500 nm, about 50 nm to about 1000 nm, about 50 nm pores or more, diameter (or height or width) pores). The surface of the quartz fibers can have a mesoporous (e.g., about 2-50 nm diameter or longest width pores) layer of TiO₂-based catalytic layer disposed thereon (e.g., about 40 to 100% of the surface area, about 40 to 90% of the surface area, or about 40 to 80% of the surface area is covered by the meso-porous layer of TiO₂-based catalytic layer). The TiO₂-based catalytic layer can be about 0.4 to 0.9 μm thick, about 0.5 to 0.8 μm thick, or about 0.6 to 0.7 μm thick, and can have a uniform thickness or un-uniform thickness. The quartz fibers coated with the TiO₂-based catalytic layer (also referred to as “coated quartz fibers”) can be included in bundles of 100s to 1000s to 10,000s or more of the quartz fibers.

The coated quartz fibers can be disposed in a structure (e.g., that can be part of a water treatment system) and water can be introduced to this material and exposed to ultraviolet (UV) illumination. In particular, the UV is in the range of 100 nm to 400 nm excitation wavelength (or about 100 to 280 nm, about 280-315 nm, about 315-400 nm, or any combination of these ranges). In this way, the water treatment system can provide in situ generation of reactive oxygen species which can break down environmental contaminants during in a UV AOP without the need to implement a separate chemical additive, be it hydrogen peroxide, ozone, or perchlorate. The treated water is decontaminated (e.g., removed enough contaminants so the water can be potable water or water usable for other purposes such as irrigation, fracking, and the like that is not potable water).

In general, the present disclosure provides for methods of treating water (e.g., contaminated water). The method can include exposing a plurality of coated quartz fibers to water of need of treatment in the presence of UV radiation (e.g., entire UV wavelength range or about 100 nm to 400 nm, or about 100 to 280 nm, about 280-315 nm, about 315-400 nm, or any combination of these ranges). Reactive oxygen species can be generated, in situ, to decontaminate the water in need of treatment and to produce decontaminated water. The water can be exposed to the UV radiation for a time period (e.g., about 1 min, about 5 min, about 10 min, about 30 min, about 1 hour about 6 hours, about 12 hours, about 1 day, about 1 week, about 2 weeks or more where these can range up to about 5 min, about 10 min, about 30 min, about 1 hour about 6 hours, about 12 hours, about 1 day, about 1 week, about 2 weeks, about 1 month, about 2 months or more). The decontaminated water can be potable water (e.g., drinking water such as that the meets state and US federal standard for consumption) or water that can be used for other purposes such as irrigation, fracking, and the like or water that can be further processed so that it is usable for the desired purpose. Producing the decontaminated water can be performed without the need to implement a separate chemical additive, optionally wherein the chemical additive is hydrogen peroxide, ozone, perchlorate, or a combination thereof.

The present disclosure also provides systems for treating water. The system can include a water flow system that functions to flow the water. In particular, the system includes a water treatment device, where the water flow system is configured to flow water into and out of the water treatment device. The water treatment device includes a structure that includes a plurality of coated quartz fibers. In addition, the water treatment device also includes a UV radiation device configured to direct UV radiation upon the coated quartz fibers. The water of need of treat is flowed into the water treatment device using the water flow system, where decontaminated water flows out of the water treatment device after exposure of the coated quartz fibers to the UV radiation. The system can produce the decontaminated water without the need to implement a separate chemical additive (e.g., hydrogen peroxide, ozone, perchlorate, or a combination thereof).

In addition, the present disclosure provides for a composition that includes a plurality of coated quartz fibers, where the coated quartz fibers comprise quartz fiber having a TiO₂-based catalytic layer on the surface of the quartz fiber. The TiO₂-based catalytic layer can be mesoporous (e.g., about 2-50 nm pores) and the quartz fibers can be macroporous (i.e., about 50 nm pores or more).

The water in need of treatment or contaminated water (e.g., non-potable water or otherwise contaminated water) can refer to industrial waste water, municipal waste water, water runoff (e.g., such as leachate from a tailings holding site, or mine dewatering), sewage, waste water from a mine, an oil processing or refining center, a coal processing center or plant, a smelting center, a disposal or incineration center, a non-ferrous metal processing center, a semiconductor fabrication center, a coal-fired power plant, aqueous mixtures from one or more of any of the forgoing, and the like, where after treatment the water can be potable water or water that can be used for irrigation, fracking, and the like or further processed so it can be used as desired.

Aspects of the present disclosure can be further described by the following:

Aspect 1. A method of treating water, comprising:

exposing a plurality of coated quartz fibers to water of need of treatment in the presence of UV radiation (e.g., entire UV wavelength range);

generating, in situ, reactive oxygen species that decontaminate the water in need of treatment; and

producing decontaminated water.

Aspect 2. The method of any of the aspects, wherein the UV radiation has a wavelength of about 100 nm to 400 nm (or about 100 to 280 nm, about 280-315 nm, about 315-400 nm, or any combination of these ranges).
Aspect 3. The method of any of the aspects, wherein the treatment in the presence of UV radiation is performed for a time frame of about mins to days (e.g., about 1 min, about 5 min, about 10 min, about 30 min, about 1 hour about 6 hours, about 12 hours, about 1 day, about 1 week, about 2 weeks or more where these can range up to about 5 min, about 10 min, about 30 min, about 1 hour about 6 hours, about 12 hours, about 1 day, about 1 week, about 2 weeks, about 1 month, about 2 months or more).
Aspect 4. The method of any of the aspects, wherein the decontaminated water is potable water, irrigation water, fracking water, or other decontaminated water that can be further processed as needed.
Aspect 5. The method of any of the aspects, wherein the coated quartz fibers comprise quartz fiber having a TiO₂-based catalytic layer on the surface of the quartz fiber.
Aspect 6. The method of any of the aspects, wherein the TiO₂-based catalytic layer is about 0.4 to 0.9 μm thick.
Aspect 7. The method of any of the aspects, wherein the quartz fiber has a diameter of about 2 to 10 μm.
Aspect 8. The method of any of the aspects, wherein the producing decontaminated water is performed without the need to implement a separate chemical additive, optionally wherein the chemical additive is hydrogen peroxide, ozone, perchlorate, or a combination thereof.
Aspect 9. A system for treating water, comprising:

a water flow system; and

the water treatment device, wherein the water flow system is configured to flow water into and out of the water treatment device, wherein the water treatment device includes a structure that includes a plurality of coated quartz fibers, wherein the water treatment device also includes a UV radiation device configured to direct UV radiation upon the coated quartz fibers, wherein water of need of treat is flowed into the water treatment device using the water flow system, wherein decontaminated water flows out of the water treatment device after exposure of the coated quartz fibers to the UV radiation.

Aspect 10. The system of any of the aspects, wherein the water flow system is operated in a continuous flow (or in the alternative in a batch mode).
Aspect 11. The system of any of the aspects, wherein the treatment of the water in the presence of UV radiation and the coated quartz fibers is performed for a time frame of about mins to days (e.g., about 1 min, about 5 min, about 10 min, about 30 min, about 1 hour about 6 hours, about 12 hours, about 1 day, about 1 week, about 2 weeks or more where these can range up to about 5 min, about 10 min, about 30 min, about 1 hour about 6 hours, about 12 hours, about 1 day, about 1 week, about 2 weeks, about 1 month, about 2 months or more).
Aspect 12. The system of any of the aspects, wherein the UV radiation has a wavelength of about 100 nm to 400 nm (or about 100 to 280 nm, about 280-315 nm, about 315-400 nm, or any combination of these ranges).
Aspect 13. The system of any of the aspects, wherein the decontaminated water is potable water, irrigation water, fracking water, or other decontaminated water that can be further processed as needed.
Aspect 14. The system of any of the aspects, wherein the coated quartz fibers comprise quartz fiber having a TiO₂-based catalytic layer on the surface of the quartz fiber.
Aspect 15. The system of any of the aspects, wherein the TiO₂-based catalytic layer is about 0.4 to 0.9 μm thick.
Aspect 16. The system of any of the aspects, wherein the quartz fiber has a diameter of about 2 to 10 μm.
Aspect 17. The system of any of the aspects, wherein the system does not implement a separate chemical additive, optionally wherein the chemical additive is hydrogen peroxide, ozone, perchlorate, or a combination thereof.
Aspect 18. A composition comprising: a plurality of coated quartz fibers, coated quartz fibers comprise quartz fiber having a TiO₂-based catalytic layer on the surface of the quartz fiber.
Aspect 19. The composition of any of the aspects, wherein the TiO₂-based catalytic layer is about 0.4 to 0.9 μm thick.
Aspect 20. The composition of any of the aspects, wherein the quartz fiber has a diameter of about 2 to 10 μm.

### EXAMPLES

Now having described the embodiments of the present disclosure, in general, example 1 describes some additional embodiments of the present disclosure. While embodiments of the present disclosure are described in connection with example 1 and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example 1

Water scarcity is a growing challenge for nations rich and poor. By 2030, humanity may require 40% more fresh water than is available today.¹ Potable water reuse can help maintain freshwater resources and is already employed in drought-prone areas such as the Western United States and Israel.² Unfortunately, current water reuse technologies can cost millions of USD per year to treat wastewater to a potable standard for small towns.^{2, 3} Approximately 10% of potable reuse costs are tied to tertiary water treatment, often involving AOPs. Nearly 40% of operations and maintenance costs for current UV-driven AOPs are tied to the use of chemical additives (e.g., H₂O₂) required by these systems.^{4, 6} Furthermore, the associated energy and chemical production required for water reuse technologies can also indirectly lead to greenhouse gas emissions contributing to anthropogenic climate change and exacerbating the issue of water scarcity—a vicious feedback loop that links water and energy˜.⁶

Photocatalytic AOPs offer potential advantages over traditional AOPs through 1) the ability to use lower energy photons, 2) the presence of catalytic surfaces for contaminant adsorption and direct breakdown, and 3) the potential cost savings by eliminating the sourcing, dosing, and quenching of chemical additives.⁸ However, previous photocatalytic technologies have largely fallen short of commercial application for several reasons. Most photocatalytic systems implement TiO₂ particles in suspension, taking advantage of high catalyst surface area with minimal mass transport limitations, however these slurry-type reactors are limited by the depth of UV penetration and require an additional costly separation step to filter suspended catalyst particles from the treated effluent.^{8, 12-14} Immobilizing the photocatalyst on a flat surface avoids the separation step but results in severe mass transport limitations. Several works have attempted to resolve both issues by immobilizing the photocatalyst on fibrous supports made of glass or plastic. While these supporting materials are transparent to visible and UVA light they act as parasitic absorbers in the UVC region. Furthermore, while visible and UVA driven photocatalytic studies are abundant in the literature they are far removed from current municipal and industrial water treatment systems which require UVC light in their AOPs.^{11, 14, 15} Studies that implement UVC radiation, the standard illumination source for municipal water treatment systems, with TiO₂ are limited but promising.^{9, 16-20}

In this example, improved supported photocatalysts as AOPs is explored by evaluating a porous TiO₂ film attached to UV-transparent quartz fibers (QF). We demonstrate, theoretically and experimentally, that this dual-porous system—mesoporous P25 films on macroporous fiber support—offers benefits over conventional supported photocatalysts in the form of increased surface area, improved mass transport, and better light management. We measure the generation of OH and the degradation of model contaminant Rhodamine B (RhB) and find that the exclusion of either porous regime is detrimental to the photocatalyst performance. As a figure of merit, we calculate the electrical energy per unit order degradation (E_{EO}) which is fundamental for assessing the commercial potential of an AOP system for water treatment.^{21, 22} We also examine the UV excitation, both in terms of intensity and wavelength, using a UVA LED—a proposed “next-generation” light source—and a low-pressure UVC bulb—the current commercial standard.¹¹ Uniquely, our QF scaffold transmits both light sources with >90% efficiency and is thus better positioned for near-term application with UVC sources than polymer, metallic, or even glass support systems.²³⁻²⁸ We apply simple transport models to our systems and use experimental results to propose further measures for photocatalyst improvement and scale-up. Finally, we use our photocatalyst to degrade pharmaceutical compounds in a river water source with nearly 30 times the treatment efficacy of traditional H₂O₂/UVC AOPs. Our P25/QF photocatalyst thus shows promise for lowering the cost of tertiary water treatment in potable reuse applications.

### Experimental

### Chemicals Used

The following chemicals and materials were used for this work: AEROXIDE® TiO₂ P25 (Evonik); acetylacetone; polyethylene glycol, MW 20,000; Triton X-100; titanium tetraisopropoxide; hydrochloric acid; sulfuric acid, pure ethanol; terephthalic acid; 2-hydroxyterephthalic acid; sodium bicarbonate; calcium chloride; humic acids; Rhodamine B; red food dye, acetaminophen, sulfamethoxazole, carbamazepine, acetonitrile, and methanol.

### Photocatalyst Fabrication

QF sheets were obtained from Saint-Gobain Quartz (USA) as Quartzveil™ sheets and were cut to size (typically 5 cm×5 cm). The Quartzveil™ sheets came pre-treated with a polyvinyl acetate (PVA) binder to help retain its shape. PVA absorbs in the UV and therefore needed to be removed to avoid parasitic absorption. To remove the PVA binder, we heated the QF veils in a tube furnace at 500° C. open to the atmosphere for 2 hours to combust the organics. UV transmission and thermogravimetric analysis (TGA) verified that the PVA was removed. Notably, we did not observe a significant loss in the structural integrity of the QF veil post binder removal.

A TiO₂ paste was synthesized using Evonik P25 TiO₂ powder in an aqueous suspension with acetylacetone, PEG, and Triton X-100 as organic binder, spacer, and surfactant, respectively. A P25 paste was synthesized by adding the following to 48 mL of deionized (DI) water, sequentially and slowly, under vigorous mixing: 0.96 mL acetylacetone (i.e., 2,4-pentadione, an organic stabilizer), 4.8 g PEG (20,000 MW, an emulsifier & void spacer) until dissolved, 12.0 g P25 powder, and 1 drop (˜20 μL) of Triton X-100 (surfactant). After vigorous mixing to homogeneity, the P25 paste was sonicated at 35 kHz for 15 min to further disperse the P25 within the paste. The P25 paste could be stored and re-used for up to 1 month, provided it was sonicated or mixed for at least 30 minutes prior to use. To fabricate P25 films on glass, Eagle XG substrates were dipped into the P25 paste and held for 30 seconds before removal with a dip coater at a withdrawal rate of 20 mm/min. Samples were then dried in air for 10 minutes and annealed in a tube furnace at 550° C. for 2 h with a 5° C./min ramp rate and cooled to room temperature overnight. When desired, thicker P25 films were fabricated by heating the samples in air at 200° C. after air drying between dip coating steps. When using the P25 paste to coat QF, the paste was diluted 10× with DI water immediately before use, and the QF veil were dip coated with the same procedure as glass substrates. After coating, the samples were dried by hanging them in air for 1 hour before annealing coated samples in the tube furnace at 550° C. for 2 h.

For non-porous TiO₂ (Tnp) samples, a sol-gel titania was created by adding 5 mL EtOH to a bottle, along with 125 μL HCl dropwise, and 1.5 mL TTIP dropwise under mixing. The sol was stirred on a stir plate for 3 h, then sealed and left overnight to set before any use. To apply Tnp to QF, the sol was diluted 5× with EtOH and dip-coated QF veils with the same procedure as previously discussed. The Tnp/QF veils were dried vertically in air for 1 h before annealing them in a tube furnace at 550° C. for 2 h.

### Photocatalyst Characterization

The QF veils were characterized by measuring the average fiber diameter using optical microscopy, calculating the substrate surface area, and validating the sample density through mass changes. These measurements and calculations are provided in the SI. QF with a 50 g/m² density was used for most studies, except in section 3.3 where the effect of catalyst loading was investigated by using QF with densities of 25 g/m² and 10 g/m². The P25/QF system was further characterized via x-ray diffraction (XRD), UV-Vis spectroscopy, scanning electron microscopy (SEM), and Brunauer-Emmett-Teller (BET) surface analysis. Details of these processes are provided in the SI.

Side-view SEM was used to measure the porous P25 film thickness (˜1.8 um), and Eq. 1 was used to calculate a mesoporous void fraction of 0.59 within the P25 film:

$$ε = 1 - \frac{{ρ}_{film}}{{ρ}_{p a r t i c l e}} \qquad ( 1 )$$

Where c is the void fraction, ρ_{film} is the measured density of our P25 film, and ρ_{particle} is the density of Evonik P25 nanoparticles (as provided by the Evonik). In the experimental studies, P25/glass samples were used with 3 layers of the P25 film applied sequentially—dried at 200° C. in between each layer addition. The 3-layer P25/glass samples absorb >62% of UVA (365 nm) light across ˜5 μm-thick films. Note that the P25 titania was unchanged by annealing samples at 550° C. from its original 80% anatase, 20% rutile composition, thus preserving the catalytically active heterojunction.³⁰⁻³²

### Experimental Setup & Photocatalytic Performance

Photocatalytic experiments were performed at pH 6.5, unless otherwise specified, and in a continuous flow reaction system (FIG. 2) using a custom-built milli-flow reactor (MFR), an in-line spectrofluorometer, and two different UV sources. The MFR has a 25 cm² quartz window for photoexcitation and provides plug-like fluid flow of up to 5 mL/min through a rectangular channel of 5 cm×5 cm×0.05 cm height (1.25 cm³). Two UV illumination sources were used in this study: a UVA LED, with a peak spectral output at 365 nm wavelength and an intensity of 3.5 mW/cm², and a UVC low-pressure mercury bulb array outputting >80% spectral intensity at 254 nm, measured at 5 mW/cm². Intensity values taken to provide an equivalent photonic flux of ˜1.6×10¹⁷ photons per second to our system. Millipore 18.2 MΩ-cm DI water was used for all photochemical experiments except when synthetic source water (SSVV) or filtered (0.45 μm) Mississippi River water (RWS) were used.

Quantification of .OH generation was performed by observing the oxidation of terephthalic acid (TPA) into the fluorescent product 2-hydroxyterepthalic acid (hTPA).^{33, 34} A 500 μM TPA solution was prepared by adding powdered TPA into water, adjusting the pH up to neutral (7) with 0.1 M NaOH, and stirring the solution at 50° C. for 12 h to fully dissolve the TPA. This stock TPA solution was diluted and the adjusted to pH 7, then used as the test solution for OH generation. After passing through the reactor, the solution entered a flow-thru cuvette mounted in a fluorometer (PTI QM 40). We excited hTPA with 350 nm light and measured its emission intensity at 425 nm to quantify the hTPA concentration. Previous studies approximate the reaction yield of hTPA in the reaction between OH and TPA at ˜30%, which we used to estimate the concentration of OH formed here.

The degradation of RhB was monitored via changes in absorbance at 554 nm. To test the destruction of pharmaceutical species, we used an Agilent 1260 Infinity high performance liquid chromatograph (HPLC) system. The samples were run for 12 minutes using a solvent gradient of acetonitrile:water from 30:70 at min 0 to 100:0 at minute 7 before returning to 30:70 at minute 10. The peaks are observed at minute 5 at a UV wavelength of 550 nm.

### Results & Discussion

### Photocatalyst Design and Operation

We assembled three immobilized photocatalyst platforms to test the novel, dual-porous system here against conventional photocatalytic device configurations. The three cases serve to test the photocatalytic performance of 1) a microporous film on a flat substrate (P25/glass), 2) a non-porous TiO₂ coating on a macroporous QF matrix (Tnp/QF), and 3) a dual-porous system having a microporous TiO₂ coating on macroporous QF (P25/QF). Each TiO₂ coating system was photoactive under UV radiation >3.2 eV (<385 nm). The P25/glass samples, and several similar designs reported elsewhere,^{12, 27, 35-40} are mass transfer limited due to a low active surface-to-volume ratio and interporous diffusion constraints, plus poor photon management. These pitfalls motivate the pursuit of multi-functional materials to solve both mass transfer and photon management challenges simultaneously.

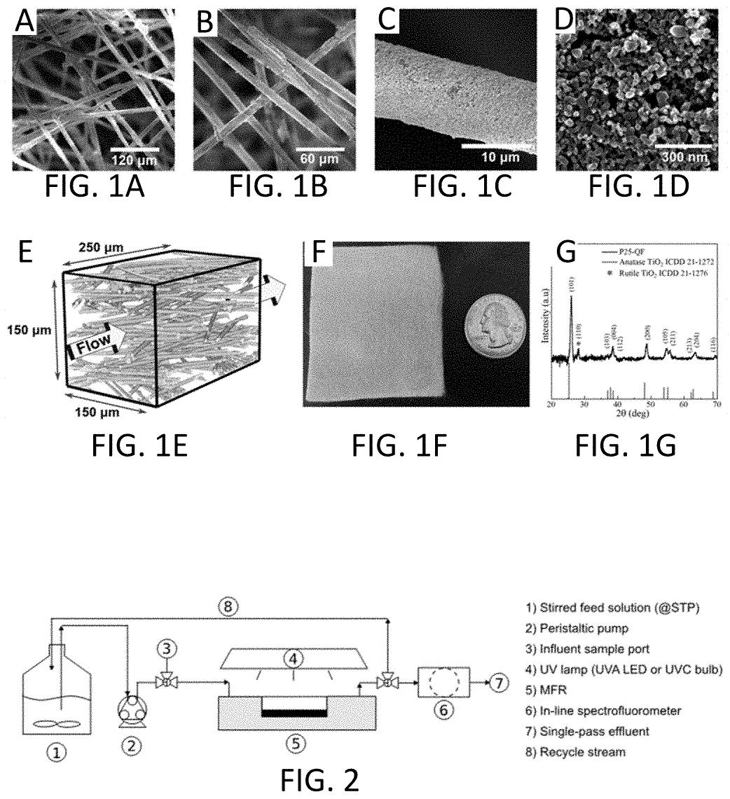

We sought to improve both mass transport in aqueous flow and UV photon management by applying a diluted P25 paste to a sample of bare QF—following the same dip-coating and sintering procedures used for P25/glass samples—to create dual-porous (P25/QF) samples. Electron micrographs revealed the macro structures of P25/QF and P25/glass (FIGS. 1A-C and 1D, respectively) and x-ray tomographs (FIG. 1E) show the random orientation of the ˜6 μm diameter QF. Rectangular sheets of P25/QF were cut with dimensions of 5 cm×5 cm×0.05 cm (FIG. 1F) for use in the custom-made MFR. XRD analysis (FIG. 1G) confirmed that the crystal structure of P25 was a mixture of anatase and rutile.

P25/QF sample characteristics were characterized for bulk and surface properties; relevant parameters are as shown in Table 1, while ancillary data and calculations are provided in Discussion S1 of the SI. The P25/QF photocatalyst contains a ˜0.65 μm thick mesoporous titania coating with an effective surface area of ˜24.3 m²/g on the macroporous (ϕ≈0.95) quartz support and a catalyst mass loading of ˜14% w/w, calculated through change in mass/density combined with BET measurements. The P25/QF photocatalyst attained a surface area to volume ratio over 400,000 m²/m³, a value much larger than photocatalysts reported by many other reports, whether supported or in suspension.¹² In contrast to this dual porous system, Tnp/QF materials were fabricated via sol-gel methods to achieve non-porous coatings on QF. The set of P25/glass, Tnp/QF, and P25/QF materials provided a platform to compare the impacts of porous regimes on the performances of supported photocatalysts.

TABLE 1
Properties of the P25/QF photocatalyst.

| Sample Properties | Value |
|---|---|
| QF Fiber Diameter (μm) | 6.2± |
| QF Area Density (g/m²) | 10-50 |
| P25 coating thickness (μm) | 0.6 |
| P25 photocatalyst loading (w/w %) | 14 |
| P25 mesoporosity (ε) | 0.59 |
| P25/QF Illuminated surface (m²/m³) | 4.0 x |
| α_{365 nm} (μm⁻¹) | 0.2 |
| α_{254 nm} (μm⁻¹) | 0.5 |

Residence time distributions act as control parameters in fundamental reactor design.⁴¹ Here, simulations estimated residence times with experimental validation for each photocatalyst assembly. The MFR operated in two regimes: 1) a single-pass method, which acted as a plug-flow reactor (with axial dispersion accounted for through the residence time distribution measurements) and utilized the spectrofluorometer to monitor contaminant or probe concentrations, and 2) a recycled batch system which provided a method to monitor contaminant degradation over time for analysis of reaction kinetics. Experiments used the single-pass system unless stated otherwise.

### Comparison of Supported Catalysts

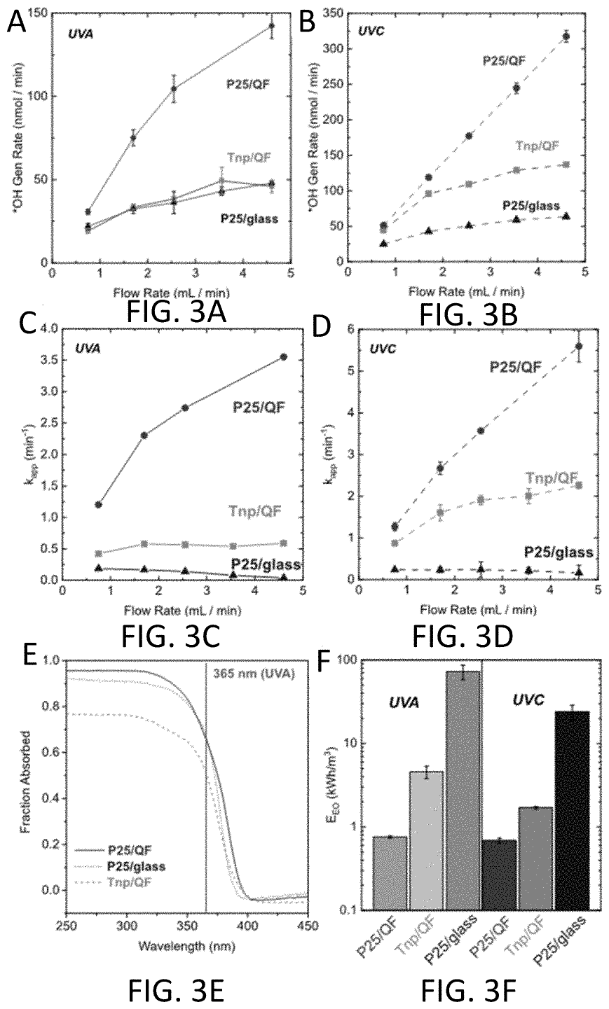

Supported photocatalyst samples were exposed to UV irradiation to test the effective ROS production. Hydroxyl radicals are the primary oxidizers in most AOPs given their high oxidation potential of 2.8 V.⁴² Transformation of TPA to hTPA, observed via fluorescence, served as an indicator for .OH.^{33, 34} Pseudo steady-state OH generation rates were estimated based on the following assumptions: 1) TPA reacts selectively with free .OH, 2) the excess concentration (500 μM) of TPA in the water reacts with bulk .OH, and 3) the reaction yield of OH with TPA to form hTPA is ˜30%.³⁴ P25/glass, Tnp/QF, and P25/QF samples were tested using varying flow rates (0.75 to 4.6 mL/min) and under UVA or UVC sources. In both UV regimes, the largest effective OH generation rate was observed with P25/QF photocatalysts (FIG. 3A-B). Observed ROS generation rates improved with flow rate for all tests, as measured by the TPA reaction. This relation between flow rate and performance suggests that mass transfer constraints limited each system, especially so in the P25/QF case.⁴³ Based on these data, we predict that further increases in flow rate would lead to a greater enhancement for P25/QF systems than for the Tnp/QF or P25/glass systems. Significantly, the P25/QF may be the first practical photocatalytic system that shows promise for scale-up, given the improvements in performance with increasing flow rates. Further, the TiO₂ loading was stable over repeated uses; the mass of P25/QF samples were unchanged and fluorescence signals of centrifuged effluent showed no loss of TiO₂.

The breakdown of the triphenylmethane dye, RhB, is important in numerous industrial wastewaters (e.g., textile, printing, food, and cosmetics.). The dye exhibits pseudo-first order kinetics and, given its popularity in similar studies, serves as a (somewhat) standardized metric for comparison.^{37, 44} A simple kinetic model for RhB photodegradation is proposed as:

$$r = - \frac{{dC}_{RhB}}{dt} = {k}_{app} {C}_{RhB} \qquad ( 2 )$$

$$∴ {k}_{app} = - \frac{ln ( \frac{{C}_{RhB}}{{C}_{RhB , 0}} )}{τ} \qquad ( 3 )$$

Where the rate of RhB degradation, r, is described by an apparent rate constant, kₐₚₚ [min⁻¹], and the concentration of RhB, C_{RhB}, as well as the residence time in reactor, τ. Here, kₐₚₚ accounts for the rate constants of several factors, including the internal mass transfer, external mass transfer, illumination intensity, and applicable reaction rate constants (i.e., RhB with .OH, electron holes, and any other ROS).

Photodegradation of 10 μM RhB solutions were measured for the different photocatalyst systems under controlled UV fluence and flowrate. The reaction rate constant, kₐₚₚ, for these trials followed similar trends of the OH generation rates (FIG. 3C-D). The ROS generation and RhB photodegradation data demonstrated that the performance of the P25/QF system was far superior to the P25/glass and Tnp/QF cases. Given that the Tnp/QF samples were more active than the P25/glass, we hypothesize that external mass transport effects are more limiting than internal mass transport within this system. That is, increasing the exposed surface area at the catalyst/bulk liquid interface does more to improve performance than does implementing a porous catalyst layer with a relatively low interfacial surface area. All things equal, the porous P25 film will outperform the non-porous Tnp film, but the QF support plays an integral role in the performance of our photocatalysts.

All photocatalyst samples achieved higher observed OH generation rates and RhB photodegradation rate constants under UVC illumination compared to UVA irradiation. This difference was likely caused by a combination of factors, including the increase in light absorbance from UVA to UVC wavelengths (FIG. 3E) and the photolysis of photo-generated H₂O₂ by UVC into OH. Given that UVC is commonly used in commercial water treatment systems for its germicidal character and ability to photolyze many contaminants, it is promising to see its effectiveness in combination with a photocatalyst—an exploration not often undertaken by photocatalysis researchers.^{11, 16, 17} The ability of quartz fibers to transmit UVC radiation with long-term stability makes the QF support highly appealing for integration within current AOP systems.

A key metric for assessing the viability of AOPs for water treatment is the electrical energy per order disinfection (E_{EO}).^{21, 22} The E_{EO} indicates how energy-efficient treatment technology is scaled over large volumes and accounting for the extent of pollutant degradation. In general, an E_{EO}<1 kWh/m³/order may be considered competitive for drinking water applications.²² For continuous flow systems, the E_{EO} can be calculated by:

$${E}_{E O} = \frac{P}{F * log ( \frac{{C}_{0}}{C} )} \qquad ( 4 )$$

where P is the radiant power from the UV source (kW), F is the volumetric flow rate (m³/hr), and C₀ and C are the concentration of pollutant at the inlet and outlet of the reactor, respectively. Using equation (4), we calculated the E_{EO} for each sample and UV condition (FIG. 3F) and once again observed the performance trend of P25/QF>>Tnp/QF>>P25/glass, with a near order of magnitude of E_{EO} separating each catalyst under UVA illumination. The E_{EO} of 0.6 kWh/m³ for P25/QF under UVA is not only a substantial improvement over the comparative photocatalysts here but is also much lower than the comparative values found for many TiO₂/UV systems in literature.^{24, 25, 37, 39}

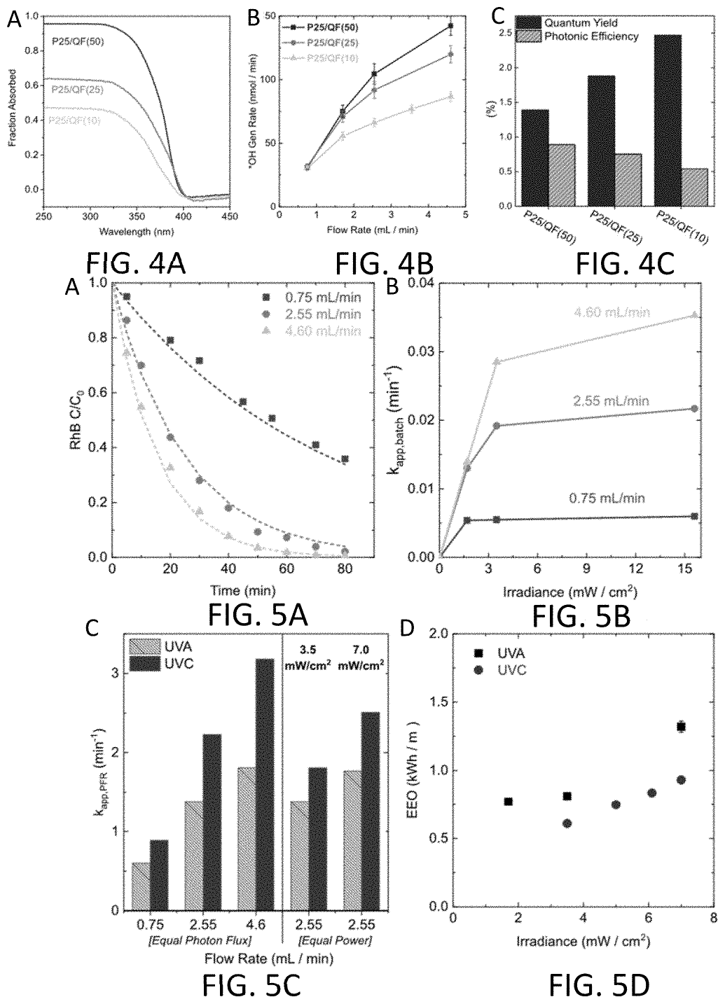

Once we established the benefits of our P25/QF system for ROS generation and pollutant degradation, we further explored the optical and mass transport impacts of the P25/QF sample by adjusting the catalyst loading. We implemented different densities of QF support loaded with the same mass % of porous P25 films. We denote these QF supports as QF(X) where X represents the density of QF in units of X g of quartz per m² of x-y surface area. We measured the optical transmission through these P25/QF(X) samples (FIG. 4A) and observed an increase in UV absorbance with catalyst thickness. Based these absorption profiles of the porous P25, we estimated an absorption coefficient at 365 nm, α_{365 nm}, for the porous P25 of ˜0.2 μm⁻¹ as defined by the equations:

$$ϕ ( x ) = {ϕ}_{0} {e}^{- α x} \qquad ( 5 )$$

$$∴ {α}_{λ} = - \frac{ln ( {T}_{λ} )}{x} \qquad ( 6 )$$

where T_{A} is the transmission of light with wavelength A through a given thickness of P25/QF and x is the thickness of P25 film as calculated based on estimated & measured P25 film thickness distributed over a cross section of QF material. The increase in optical absorption with sample loading had a clear impact on both the ROS generation rate and RhB degradation (FIG. 4B). However, when we normalized the OH generation and RhB degradation rates to the fraction of UVA light absorbed, we found that the normalized performance amongst P25/QF(X) samples trended the opposite direction—that is, P25/QF(10) had a better absorbance-normalized photocatalytic activity than P25/QF(50) (FIG. 4C). This distinction was expressed in terms of quantum yield vs. the photonic efficiency⁴⁵:

$$Quantum Yield = Φ = \frac{\# molecules reacted}{\# photons absorbed} \qquad ( 7 )$$

$$Photonic Efficiency = ξ = \frac{reaction rate}{photonic flux} \qquad ( 8 )$$

Based on the improved quantum yield with lower catalyst density, we propose that a scaled-up of this system would be better suited with a lower volumetric catalytic loading (mg/m³) to provide better optical transport. We discuss this hypothesis in relation to optical path length in the next section. We also hypothesize that there is a lower limit to catalytic loading whereby the mass transfer will suffer in relation to optical transport, thus further testing of catalyst loading is required to optimize the density.

### Mass and Optical Transport Models

We formed a basic theoretical framework to understand the comparative performance of the photocatalyst and to build upon for scaling-up to larger water treatment systems. We proposed several parameters which influence the system: 1) fluid flow profile, 2) catalyst loading and surface area, 3) internal mass transport, 4) external mass transport, 5) UV excitation of the catalyst.

We established a residence time of bulk fluid through our reactor through a series of pulsed dye tests. The results showed near plug flow profiles for systems with and without QF, though the presence of QF(50) increased the axial dispersion of our system from 0.028 cm²/s to 0.036 cm²/s which we account for through the change in Bodenstein number from a value of 30.3 without QF to 23.7 with QF. The decrease in Bodenstein number corresponds to an increase in back mixing in our system. We further described the flow in our system through Reynold's number, which was calculated to be 3.07 for the non-QF system at 4.6 mL/min flow and 0.49 for the QF system at same flow using a modified Reynold's number for flow through porous media. The transition to turbulent flow happens at different values for traditional and modified Reynold's numbers (Re>2000, and Re>10, respectively), so the relative turbulence of the QF and non-QF systems is difficult to assess but the flow in both systems is clearly laminar. Using this Reynold's number, and the Schmidt number (ν/D_{ab}), we also approximate the external mass transfer coefficients (Table 2) through a set of mass transfer correlations.

One important characteristic of our photocatalyst is the total loading of P25 within the reaction chamber. For P25/QF, the catalyst loading is ˜18.6 g/L, much higher than many other ratios reported in literature.¹² Previous studies have suggested that suspended TiO₂ catalyst loads of <2 g/L are ideal from an efficiency standpoint,^{37, 46, 47} which may help explain the higher quantum yield of P25/QF(10) vs. P25/QF(50), where the TiO₂ loading is ˜3.7 g/L respectively.

As seen in the prior section, P25/QF systems having a lower catalytic loading with respect to the MFR volume also achieved higher the photonic efficiencies. One way to assess this information is to consider the optical path length through each P25/QF loading.⁴⁸ Here, the optical path length is defined as the depth through which UV illumination can penetrate before being attenuated e-fold by the P25/QF at a given density. This calculation is based on the absorption Beer-Lamber law, provided in equation (5). We normalized the absorption coefficients of P25/QF(X) samples to the fixed depth of the MFR (500 μm) and back-calculated the optical path lengths, provided in Table 2. Note that the P25/glass sample was evaluated at the fixed P25 film thickness of 5 um. As the P25/QF becomes less dense with respect to the reactor volume, the penetration depth of UV light increases. Therefore, when attempting to optimize and scale up this P25/QF system, one design priority could be to achieve a higher optical path length, or lower catalytic loading density, to improve the overall energy efficiency of the system and lower operation costs.

TABLE 2
Characteristics and Performance Metrics for Photocatalysts Under UVA.

| | | | | | UVA | | |
|---|---|---|---|---|---|---|---|
| | | Specific | | Est. Mass | Optical | | |
| | Axial | Surface | Catalyst | Transfer | Path | Quantum | RhB Deg |
| | Dispersion | Area | Loading | Coefficient | Length | Efficiency | UVA E_{EO} |
| Sample | (cm²/s) | (m²/g) | (mg) | (cm/s, × 10⁻⁴) | (μm) | (%) | (kWh/m³) |
| P25/glass | 0.028 | 24.3 | 4.68 | 6.35 | 4 | 0.46 | 72.6 |
| Tnp/QF | 0.036 | 3.1 | 4.5 | 12.6 | 681 | 0.55 | 4.6 |
| P25/QF (10) | n/a | 24.3 | 4.7 | 12.6 | 2012 | 2.47 | 1.94 |
| P25/QF (25) | n/a | 24.3 | 10.1 | 12.6 | 979 | 1.88 | 1.41 |
| P25/QF (50) | 0.036 | 24.3 | 22.7 | 12.6 | 382 | 1.39 | 0.76 |

### Recycled Batch Tests and Evaluating P25/QF Performance

To better understand the P25/QF photocatalyst performance with respect to UV intensity and longer-term performances, recycled batch tests were implemented. These tests were used to measure pollutant degradation trends and to calculate apparent reaction rates.

Degradation tests were conducted on 10 μM RhB solutions in DI water under different recycled flow rates between 0.75 to 4.6 ml/min (FIG. 5A). UVA irradiation was used via a UV lamp, allowing for 30 min of warming up time for the lamp. Samples were taken from both the batch reactor and the single-pass effluent to estimate the single-pass degradation of RhB in the UV/catalyst system. Model equation (9) was used to compare the values:⁴⁹

$${X}_{batch} = 1 - exp [ - ( \frac{t}{{τ}_{b}} ) {X}_{PFR} ] \qquad ( 9 )$$

With X_{“reactor”} denoting the conversion (i.e., degradation) of RhB measured from the batch or PFR reactor sample, t being the time passed, and m denoting the average residence time of species in the batch reactor (i.e., Vol_{batch} IF). The single-pass conversion data was used to model the degradation curves in FIG. 5A (dashed lines) and provide a good fit with the measured batch data (R²>0.99 in all cases). A least means squared analysis of the experimental vs calculated residuals was implemented to extract apparent rate constants with greater statistical significance.

The effect of UV intensity on the performance of P25/QF was examined using recycled batch tests. The incident illumination power was regulated between 1.5 to 15.3 mW/cm² by adjusting the lamp distance from the photocatalytic system and the resultant degradation of RhB was measured at different flow rates (FIG. 5B). At low flow rates, the degradation of RhB was independent of the light intensity with nearly all molecules destroyed. However, at higher flow rates, higher illumination results in greater and quicker degradation. This suggests that the flow rate needs to be high enough to not be the limiting factor.

To test the effects of the different UV illumination sources on the yield of OH in the recycled-batch setup, we held the photon flux equal for UVA and UVC illumination, as done for previous tests, at 1.6×10¹⁷ photons/s, corresponding to 3.5 mW/cm² and 5.0 mW/cm² of UVA and UVC radiation, respectively. These tests (FIG. 5C) confirmed the benefits of UVC radiation and higher flow rates for pollutant degradation as expected. For the purposes of judging the electrical efficiency, tests were conducted to measure the power output of the different UV sources, given that this parameter is used directly within E_{EO} calculations. Even at equal irradiance, the UVC illumination provided better RhB degradation rates than UVA. This, along with the germicidal and photolytic benefits inherent in UVC water treatment, attest to the promising potential of implementing UVC lamps with this photocatalyst, a unique advantage stemming from the use of the QF support. This advantage was further quantified through the recycled-batch E_{EO} calculations for RhB degradation (FIG. 5D), which not only showed that UVC performs better energetically than UVA with P25/QF photocatalysts but indicated that lower lamp power yielded better E_{EO} metrics. As previously suggested in Section 3.4, lower light intensity per volume of photocatalyst could be used to optimize photocatalyst performance.

Comparison with H₂O₂/UVC for RhB and Pharmaceutical Degradation in Alternate Water Sources

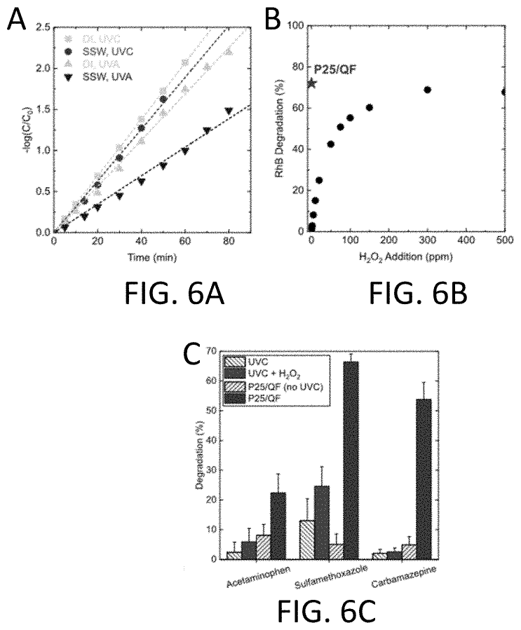

A synthetic source water (SSVV) was developed by selectively adding chemical components typically found within surface waters.^{5, 10, 21, 50} Varying levels of sodium bicarbonate were added to the SSW system to provide alkalinity in the range found in soft to medium-hard drinking water, while maintaining the pH at 6.5. Carbonate and bicarbonate are often implicated as primary scavengers of OH within drinking water systems, with second-order reaction rate constants of 3.9×10⁸ and 8.5×10⁶ (L mol⁻¹ sec⁻¹), respectively.^{21, 51} An addition of up to 800 mg/L of NaHCO₃ (i.e. 400 ppm alkalinity as CaCO₃) had a negligible impact on the performance of the P25/QF photocatalyst under UVA or UVC illumination. Furthermore, adding 70 mg/L of CaCl₂) to augment the ionic conductivity also did not alter the performance of the photocatalyst. We then added 2 mg/L of un-filtered humic acids (HA) to form our final SSW, with water quality parameters provided in Table 2. The unfiltered HA has an adverse effect on the P25/QF performance due to adsorption of HA to the P25 surface (i.e., catalyst fouling), as shown in FIG. 6A. The HA may also reduce UV transmission and scavenge ROS.⁶²⁻⁶⁴ Notably, the impact of HA on the P25/QF is greater when under UVA illumination than under UVC.

TABLE 3
SSW and RWS characteristics

| Parameter | SSW | RWS |
|---|---|---|
| pH | 6.5 | 7.8 |
| Temperature (° C.) | 20 | 20 |
| UVT₃₆₅ (%) | 93.6 | — |
| UVT₂₅₄ (%) | 69.2 | 78.4 |
| Humic Acids (mg/L) | 2.0 | — |
| TOC (mg-C/L) | 5.0 | 1.9 |
| Alkalinity (as mg CaCO₃²⁻/L) | 200 | — |

We compared the performance of our P25/QF photocatalyst for RhB breakdown to that of a traditional H₂O₂/UVC AOP. Initially, we added concentrations of 5 to 500 ppm of H₂O₂ to our SSW and measured the relative RhB degradation under UVC illumination without the presence of a P25/QF sample. Increasing the H₂O₂ concentration resulted in better RhB degradation (FIG. 6B) with diminishing returns for increasing H₂O₂ doses above 50 ppm. In many commercial H₂O₂/UVC reactors, 50 ppm marks the maximum H₂O₂ dosage utilized, though often concentrations of 5 to 20 ppm H₂O₂ are used, depending on the specific treatment goals.¹⁰ In the absence of light, no RhB degradation was observed. Comparatively, our P25/QF photocatalyst under UVC illumination attained an RhB degradation 2.5× greater than that through the addition of 50 ppm H₂O₂, at a controlled flow rate of 4.6 mL/min. Even with a dosage of 300 ppm H₂O₂, which provided the maximum RhB degradation in the MFR, the P25/QF exhibited superior pollutant degradation. This is a very promising result indicative of the potential benefits of P25/QF for a chemical-free AOP in water treatment.

The P25/QF photocatalyst was also tested for the degradation of various pharmaceutical compounds of concern. A river water source (RWS) was spiked with 10 ppm of model contaminants (acetaminophen, sulfamethoxazole, and carbamazepine) and introduced to the MFR at 4.6 mL/min under various catalytic conditions. The water quality profile for the RWS is provided in Table 3, and the results of the pharmaceutical degradation test are provided in FIG. 6C. In the case of all three contaminants, with ˜27 seconds residence time within the MFR, use of the P25/QF under UVC illumination greatly outperformed that of UVC alone or UVC with 6 ppm of H₂O₂ addition. While sulfamethoxazole underwent the greatest degradation under UVC, H₂O₂/UVC, and P25/QF, the greatest improvement of the P25/QF activity over H₂O₂/UVC AOP was for carbamazepine. The comparative E_{EO} for pharmaceutical breakdown using these technologies is provided in Table 4. Furthermore, testing with P25/QF under dark conditions suggested limited adsorption of each compound on the P25 surface. The long-term impact of this adsorption requires further investigation.

TABLE 4
Comparison of E_{EO} for pharmaceutical compound degradation
using traditional H₂O₂/UVC and our P25/QF photocatalyst.

| E_{EO} (kWh/m³) | Acetaminophen | Sulfamethoxazole | Carbamazepine |
|---|---|---|---|
| H₂O₂/UVC | 17.25 | 3.69 | 40.04 |
| P25/QF | 4.07 | 0.96 | 1.35 |
| Improvement | 424% | 384% | 2966% |

### CONCLUSION

With this work, we developed an immobilized, titania-based photocatalyst, and demonstrated its ability to degrade a variety of organic compounds in different water aqueous environments with competitive efficiencies as commercial H₂O₂/UVC AOP as measured through the E_{EO} metric. The P25/QF AOP photocatalyst is unique in that it implements dual-scale porosity, overcoming some of the limitations in mass and optical transport that currently plague the field of photocatalytic advanced oxidation. We performed some initial analysis on the fundamental improvements of the P25/QF system compared to other photocatalytic architectures and found that, while the current system provides substantial benefits to photocatalytic activity, further tuning of the photocatalyst density, incident optical power, and flow rate could improve the performance further, in terms of both quantum efficiency and overall degradation rates. We also confirmed the activity of the P25/QF photocatalyst under both UVA and UVC illumination, opening the door to its use in a wide range of technological platforms. Further optimization of the P25/QF system could benefit tertiary water treatment efforts by eliminating the need for chemical additives, reducing the energetic cost of treatment, and simplifying the equipment used in treatment trains to remove harmful organic compounds. While the potential to use UVA and solar radiation is energetically appealing, we believe serious investigations of photocatalysts for large-scale water treatment applications are bolstered by examining their efficacy under UVC radiation that is already implemented in many commercial systems. Further studies with specific source waters, pre-treatments, and regeneration techniques are needed to fully assess the long-term potential for the P25/QF photocatalyst for commercial water treatment.^{3, 10}

### REFERENCES, EACH OF WHICH IS INCORPORATED HEREIN BY REFERENCE

1. Agoncillo, J. 2020 Annual Report: Valuing Water, Enabling Change; 2030 Water Resources Group: November 2020, 2020; p 42.
2. Schmitz, L.; Reinhold, U.; Bierhoff, E.; Dirschka, T., Optical coherence tomography: its role in daily dermatological practice. JDDG: Journal der Deutschen Dermatologischen Gesellschaft 2013, 11 (6), 499-507.
3. Brongersma, M. L.; Halas, N. J.; Nordlander, P., Plasmon-induced hot carrier science and technology. Nature Nanotechnology 2015, 10, 25.
4. Plumlee, M. H.; Stanford, B. D.; Debroux, J.-F.; Hopkins, D. C.; Snyder, S. A., Costs of Advanced Treatment in Water Reclamation. Ozone: Science & Engineering 2014, 36 (5), 485-495.
5. Guidance Document for Integrating UV-based Advanced Oxidation Processes (AOPs) Into Municipal Wastewater Treatment Plants; Ministry of the Environment and Climate Change: January 2015, 2015.
6. Liu, Y.; Hejazi, M.; Kyle, P.; Kim, S. H.; Davies, E.; Miralles, D. G.; Teuling, A. J.; He, Y.; Niyogi, D., Global and Regional Evaluation of Energy for Water. Environmental Science & Technology 2016, 50 (17), 9736-9745.
7. Fujishima, A.; Honda, K., Electrochemical Photolysis of Water at a Semiconductor Electrode. Nature 1972, 238 (5358), 37-38.
8. Loeb, S. K.; Alvarez, P. J. J.; Brame, J. A.; Cates, E. L.; Choi, W.; Crittenden, J.; Dionysiou, D. D.; Li, Q.; Li-Puma, G.; Quan, X.; Sedlak, D. L.; David Waite, T.; Westerhoff, P.; Kim, J.-H., The Technology Horizon for Photocatalytic Water Treatment: Sunrise or Sunset? Environmental Science & Technology 2019, 53 (6), 2937-2947.
9. Suzuki, H.; Araki, S.; Yamamoto, H., Evaluation of advanced oxidation processes (AOP) using O3, UV, and TiO2 for the degradation of phenol in water. Journal of Water Process Engineering 2015, 7, 54-60.
10. Groeneveld, R. H. M.; Sprik, R.; Lagendijk, A., Effect of a nonthermal electron distribution on the electron-phonon energy relaxation process in noble metals. Physical Review B 1992, 45 (9), 5079-5082.
11. Matafonova, G.; Batoev, V., Recent advances in application of UV light-emitting diodes for degrading organic pollutants in water through advanced oxidation processes: A review. Water Research 2018, 132, 177-189.
12. Van Gerven, T.; Mul, G.; Moulijn, J.; Stankiewicz, A., A review of intensification of photocatalytic processes. Chemical Engineering and Processing: Process Intensification 2007, 46 (9), 781-789.
13. Balasubramanian, G.; Dionysiou, D. D.; Suidan, M. T.; Baudin, I.; Lathe, J.-M., Evaluating the activities of immobilized TiO₂ powder films for the photocatalytic degradation of organic contaminants in water. Applied Catalysis B: Environmental 2004, 47 (2), 73-84.
14. Pelaez, M.; Nolan, N. T.; Pillai, S. C.; Seery, M. K.; Falaras, P.; Kontos, A. G.; Dunlop, P. S. M.; Hamilton, J. W. J.; Byrne, J. A.; O'Shea, K.; Entezari, M. H.; Dionysiou, D. D., A review on the visible light active titanium dioxide photocatalysts for environmental applications. Applied Catalysis B: Environmental 2012, 125, 331-349.
15. Alaton, I. A.; Balcioglu, I. A.; Bahnemann, D. W., Advanced oxidation of a reactive dyebath effluent: comparison of O3, H2O2/UV-C and TiO2/UV-A processes. Water Research 2002, 36 (5), 1143-1154.
16. Nasuhoglu, D.; Yargeau, V.; Berk, D., Photo-removal of sulfamethoxazole (SMX) by photolytic and photocatalytic processes in a batch reactor under UV-C radiation (λmax=254 nm). Journal of Hazardous Materials 2011, 186 (1), 67-75.
17. Eskandarian, M. R.; Choi, H.; Fazli, M.; Rasoulifard, M. H., Effect of UV-LED wavelengths on direct photolytic and TiO2 photocatalytic degradation of emerging contaminants in water. Chemical Engineering Journal 2016, 300, 414-422.
18. Durán-Alvarez, J. C.; Avella, E.; Ramirez-Zamora, R. M.; Zanella, R., Photocatalytic degradation of ciprofloxacin using mono- (Au, Ag and Cu) and bi- (Au—Ag and Au—Cu) metallic nanoparticles supported on TiO2 under UV-C and simulated sunlight. Catalysis Today 2016, 266, 175-187.
19. Zhou, T.; Lim, T.-T.; Chin, S.-S.; Fane, A. G., Treatment of organics in reverse osmosis concentrate from a municipal wastewater reclamation plant: Feasibility test of advanced oxidation processes with/without pretreatment. Chemical Engineering Journal 2011, 166 (3), 932-939.
20. Yang, L.; Yu, L. E.; Ray, M. B., Degradation of paracetamol in aqueous solutions by TiO2 photocatalysis. Water Research 2008, 42 (13), 3480-3488.
21. Keen, O.; Bolton, J.; Litter, M.; Bircher, K.; Oppenlander, T., Standard reporting of Electrical Energy per Order (EEO) for UV/H₂O₂ reactors (IUPAC Technical Report). Pure and Applied Chemistry 2018, 90 (9), 1487-1499.
22. Bolton, J. R.; Bircher, K. G.; Tumas, W.; Tolman, C. A., Figures-of-merit for the technical development and application of advanced oxidation technologies for both electric- and solar-driven systems (IUPAC Technical Report). Pure and Applied Chemistry 2001, 73 (4), 627-637.
23. Jayamohan, H.; Smith, Y. R.; Gale, B. K.; Mohanty, S. K.; Misra, M., Photocatalytic microfluidic reactors utilizing titania nanotubes on titanium mesh for degradation of organic and biological contaminants. Journal of Environmental Chemical Engineering 2016, 4 (1), 657-663.
24. Lee, C.-G.; Javed, H.; Zhang, D.; Kim, J.-H.; Westerhoff, P.; Li, Q.; Alvarez, P. J. J., Porous Electrospun Fibers Embedding TiO2 for Adsorption and Photocatalytic Degradation of Water Pollutants. Environmental Science & Technology 2018, 52 (7), 4285-4293.
25. Li, L.; Chen, R.; Zhu, X.; Wang, H.; Wang, Y.; Liao, Q.; Wang, D., Optofluidic Microreactors with TiO2-Coated Fiberglass. ACS Applied Materials & Interfaces 2013, 5 (23), 12548-12553.
26. Oblak, R.; Kete, M.; Štangar, U. L.; Tasbihi, M., Alternative support materials for titania photocatalyst towards degradation of organic pollutants. Journal of Water Process Engineering 2018, 23, 142-150.
27. Palau, J.; Colomer, M.; Penya-Roja, J. M.; Martinez-Soria, V., Photodegradation of Toluene, m-Xylene, and n-Butyl Acetate and Their Mixtures over TiO2 Catalyst on Glass Fibers. Industrial & Engineering Chemistry Research 2012, 51 (17), 5986-5994.
28. Zhang, S.; Zhang, J.; Sun, J.; Tang, Z., Capillary microphotoreactor packed with TiO2-coated glass beads: An efficient tool for photocatalytic reaction. Chemical Engineering and Processing—Process Intensification 2020, 147, 107746.
29. Dunlop, P. S. M.; Galdi, A.; McMurray, T. A.; Hamilton, J. W. J.; Rizzo, L.; Byrne, J. A., Comparison of Photocatalytic Activities of Commercial Titanium Dioxide Powders Immobilised on Glass Substrates. Journal of Advanced Oxidation Technologies 2010, 13 (1), 99-106.
30. Carneiro, J. T.; Savenije, T. J.; Moulijn, J. A.; Mul, G., How Phase Composition Influences Optoelectronic and Photocatalytic Properties of TiO2. The Journal of Physical Chemistry C 2011, 115 (5), 2211-2217.
31. Wahab, A. K.; Ould-Chikh, S.; Meyer, K.; Idriss, H., On the “possible” synergism of the different phases of TiO2 in photo-catalysis for hydrogen production. Journal of Catalysis 2017, 352, 657-671.
32. Parrino, F.; Bellardita, M.; Garcia-Lopez, E. I.; Marci, G.; Loddo, V.; Palmisano, L., Heterogeneous Photocatalysis for Selective Formation of High-Value-Added Molecules: Some Chemical and Engineering Aspects. ACS Catalysis 2018, 8 (12), 11191-11225.
33. Burns, J. M.; Cooper, W. J.; Ferry, J. L.; King, D. W.; DiMento, B. P.; McNeill, K.; Miller, C. J.; Miller, W. L.; Peake, B. M.; Rusak, S. A.; Rose, A. L.; Waite, T. D., Methods for reactive oxygen species (ROS) detection in aqueous environments. Aquatic Sciences 2012, 74 (4), 683-734.
34. Page, S. E.; Arnold, W. A.; McNeill, K., Terephthalate as a probe for photochemically generated hydroxyl radical. Journal of Environmental Monitoring 2010, 12 (9), 1658-1665.
35. Khataee, A. R.; Fathinia, M.; Aber, S., Kinetic Modeling of Liquid Phase Photocatalysis on Supported TiO2 Nanoparticles in a Rectangular Flat-Plate Photoreactor. Industrial & Engineering Chemistry Research 2010, 49 (24), 12358-12364.
36. Chen, D.; Li, F.; Ray, A. K., External and internal mass transfer effect on photocatalytic degradation. Catalysis Today 2001, 66 (2), 475-485.
37. Natarajan, T. S.; Thomas, M.; Natarajan, K.; Bajaj, H. C.; Tayade, R. J., Study on UV-LED/TiO2 process for degradation of Rhodamine B dye. Chemical Engineering Journal 2011, 169 (1), 126-134.
38. Nielsen, M. G.; In, S.-I.; Vesborg, P. C. K.; Pedersen, T.; Almtoft, K. P.; Andersen, I. H.; Hansen, O.; Chorkendorff, I., A generic model for photocatalytic activity as a function of catalyst thickness. Journal of Catalysis 2012, 289, 62-72.
39. Shen, C.; Wang, Y. J.; Xu, J. H.; Luo, G. S., Glass capillaries with TiO2 supported on inner wall as microchannel reactors. Chemical Engineering Journal 2015, 277, 48-55.
40. Turchi, C. S.; Ollis, D. F., Comment. Photocatalytic reactor design: an example of mass-transfer limitations with an immobilized catalyst. The Journal of Physical Chemistry 1988, 92 (23), 6852-6853.
41. Gobert, S. R. L.; Kuhn, S.; Braeken, L.; Thomassen, L. C. J., Characterization of Milli- and Microflow Reactors: Mixing Efficiency and Residence Time Distribution. Organic Process Research & Development 2017, 21 (4), 531-542.
42. Legrini, O.; Oliveros, E.; Braun, A. M., Photochemical processes for water treatment. Chemical Reviews 1993, 93 (2), 671-698.
43. Fogler, H. S., Elements of chemical reaction engineering. Third edition. Upper Saddle River, N.J.: Prentice Hall PTR, [1999] © 1999: 1999.
44. Yu, K.; Yang, S.; He, H.; Sun, C.; Gu, C.; Ju, Y., Visible Light-Driven Photocatalytic Degradation of Rhodamine B over NaBiO3: Pathways and Mechanism. The Journal of Physical Chemistry A 2009, 113 (37), 10024-10032.
45. Su, Y.; Straathof, N. J. W.; Hessel, V.; Noel, T., Photochemical Transformations Accelerated in Continuous-Flow Reactors: Basic Concepts and Applications. Chemistry—A European Journal 2014, 20 (34), 10562-10589.
46. lmoberdorf, G. E.; Vella, G.; Sclafani, A.; Rizzuti, L.; Alfano, O. M.; Cassano, A. E., Radiation model of a TiO2-coated, quartz wool, packed-bed photocatalytic reactor. AlChE Journal 2010, 56 (4), 1030-1044.
47. Zhang, D., Heterogeneous photocatalytic removal and reaction kinetics of Rhodamine-B dye with Au loaded TiO2 nanohybrid catalysts. Polish Journal of Chemical Technology 2012, 14 (2), 42-48.
48. Attard, G.; Barnes, C., Surfaces. Oxford University Press: 1998.
49. Atlas, H.; Resnick, W., Analysis of batch-recycle reactor systems. The Canadian Journal of Chemical Engineering 1976, 54 (6), 639-641.
50. Krishnan, S.; Rawindran, H.; Sinnathambi, C. M.; Lim, J. W., Comparison of various advanced oxidation processes used in remediation of industrial wastewater laden with recalcitrant pollutants. IOP Conference Series: Materials Science and Engineering 2017, 206, 012089.
51. Buxton, G. V.; Greenstock, C. L.; Heiman, W. P.; Ross, A. B., Critical Review of rate constants for reactions of hydrated electrons, hydrogen atoms and hydroxyl radicals (.OH/.O— in Aqueous Solution. Journal of Physical and Chemical Reference Data 1988, 17 (2), 513-886.
52. Maghsoodi, M.; Jacquin, C.; Teychené, B.; Heran, M.; Tarabara, V. V.; Lesage, G.; Snow, S. D., Emerging investigator series: photocatalysis for MBR effluent post-treatment: assessing the effects of effluent organic matter characteristics. Environmental Science: Water Research & Technology 2019, 5 (3), 482-494.
53. Vione, D.; Falletti, G.; Maurino, V.; Minero, C.; Pelizzetti, E.; Malandrino, M.; Ajassa, R.; Olariu, R.-I.; Arsene, C., Sources and Sinks of Hydroxyl Radicals upon Irradiation of Natural Water Samples. Environmental Science & Technology 2006, 40 (12), 3775-3781.
54. Yuan, F.; Hu, C.; Hu, X.; Qu, J.; Yang, M., Degradation of selected pharmaceuticals in aqueous solution with UV and UV/H2O2. Water Research 2009, 43 (6), 1766-1774.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an aspect, the term “about” can include traditional rounding according to significant figures of the numerical value. In addition, the phrase “about ‘x’ to ‘y’” includes “about ‘x’ to about ‘y’”. Many variations and modifications may be made to the above-described aspects. All such modifications and variations are intended to be included herein within the scope of this disclosure and protected by the following claims.

We claim at least the following:

1. A method of treating water, comprising:
exposing a plurality of coated quartz fibers to water of need of treatment in the presence of UV radiation;
generating, in situ, reactive oxygen species that decontaminate the water in need of treatment; and
producing decontaminated water.

2. The method of claim 1, wherein the UV radiation has a wavelength of about 200 nm to 400 nm.

3. The method of claim 1, wherein the treatment in the presence of UV radiation is performed for a time frame of about mins to days.

4. The method of claim 1, wherein the coated quartz fibers comprise quartz fiber having a TiO₂-based catalytic layer on the surface of the quartz fiber.

5. The method of claim 4, wherein the TiO₂-based catalytic layer is about 0.4 to 0.9 μm thick.

6. The method of claim 1, wherein the quartz fiber has a diameter of about 2 to 10 μm.

7. The method of claim 1, wherein the producing decontaminated water is performed without the need to implement a separate chemical additive, wherein the chemical additive is hydrogen peroxide, ozone, perchlorate, or a combination thereof.

8. A system for treating water, comprising:
a water flow system; and
the water treatment device, wherein the water flow system is configured to flow water into and out of the water treatment device, wherein the water treatment device includes a structure that includes a plurality of coated quartz fibers, wherein the water treatment device also includes a UV radiation device configured to direct UV radiation upon the coated quartz fibers, wherein water of need of treat is flowed into the water treatment device using the water flow system, wherein decontaminated water flows out of the water treatment device after exposure of the coated quartz fibers to the UV radiation.

9. The system of claim 8, wherein the water flow system is operated in a continuous flow.

10. The system of claim 8, wherein the treatment of the water in the presence of UV radiation and the coated quartz fibers is performed for a time frame of about mins to days.

11. The system of claim 8, wherein the UV radiation has a wavelength of about 200 nm to 400 nm.

12. The system of claim 8, wherein the coated quartz fibers comprise quartz fiber having a TiO₂-based catalytic layer on the surface of the quartz fiber.

13. The system of claim 12, wherein the TiO₂-based catalytic layer is about 0.4 to 0.9 μm thick.

14. The system of claim 8, wherein the quartz fiber has a diameter of about 2 to 10 μm.

15. The system of claim 8, wherein the system does not implement a separate chemical additive, wherein the chemical additive is hydrogen peroxide, ozone, perchlorate, or a combination thereof.

16. A composition comprising: a plurality of coated quartz fibers, wherein the coated quartz fibers comprise quartz fiber having a TiO₂-based catalytic layer on the surface of the quartz fiber.

17. The composition of claim 16, wherein the TiO₂-based catalytic layer is about 0.4 to 0.9 μm thick.

18. The composition of claim 16, wherein the quartz fiber has a diameter of about 2 to 10 μm.
